(19) United States
(12) Patent Application Publication
(10) Pub. No.: US 2024/0145223 A1
(43) Pub. Date: May 2, 2024

(54) MASS SPECTROMETER AND METHOD FOR SETTING ANALYSIS CONDITION

(71) Applicant: SHIMADZU CORPORATION, Kyoto (JP)

(72) Inventor: Tomoyoshi MATSUSHITA, Kyoto (JP)

(73) Assignee: SHIMADZU CORPORATION, Kyoto (JP)

(21) Appl. No.: 18/383,919

(22) Filed: Oct. 26, 2023

(30) Foreign Application Priority Data
Oct. 28, 2022 (JP) 2022-173491

(51) Int. Cl. H01J 49/00; H01J 49/10

(52) U.S. Cl. CPC H01J 49/0036; H01J 49/105

(57) ABSTRACT

An ICP-MS includes a control device, a collision cell and a first electrode that are provided on an optical axis of plasma, and a second electrode, a mass separation device, and a detector that are provided on a detection axis. The control device sets, as an axis-shifting voltage to be applied to each electrode of the first electrode and the second electrode in a gas-present mode, the voltage obtained by adding an offset determined according to a mass-to-charge ratio of a target ion to an initial voltage in a gasless mode.

### CROSS REFERENCE TO RELATED APPLICATIONS

This nonprovisional application is based on japanese Patent Application No. 2022-173491 filed on Oct. 28, 2022 with the Japan Patent Office, the entire content of which is hereby incorporated by reference.

### BACKGROUND OF THE INVENTION

### Field of the Invention

The present invention relates to a mass spectrometer and a method for setting an analysis condition in the mass spectrometer.

### Description of the Background Art

An inductively coupled plasma (ICP) mass spectrometer (hereinafter referred to as an “ICP-MS”) using an ICP ion source as an ion source is known. The ICP-MS ionizes a sample by an ion source, separates ions on a mass-to-charge ratio basis by a mass separation section, and detects each ion separated on a mass-to-charge ratio basis by a detector. In the ICP-MS, the ion source is provided in a substantially atmospheric pressure ambience. Ions and the like which have been generated by ionization using the ion source are taken into a vacuum chamber maintained in a substantially vacuum ambience, passed through the mass separation section provided in the vacuum chamber, and detected by the detector.

Not only target ions to be measured, but also interfering particles that interfere with the measurement of the target ions are also introduced into the vacuum chamber. The interfering particles include, for example, those originating from gases such as argon (Ar) to be used for generation of plasma in the ion source, contaminants contained in a sample liquid, and those originating from additives to be added to the sample liquid. Various methods have been used to remove such interfering particles.

For example, Japanese Patent Laying-Open No. 2020-91988 discloses that a collision cell is provided to create a difference between the kinetic energy of interfering ions as interfering particles and the kinetic energy of target ions to form an energy barrier at the exit of the collision cell, thereby separating and removing the interfering ions from the target ions.

Further, WO2002/019382 discloses an ICP-MS in which an aperture of a plate serving as an inlet of a collision cell is offset with respect to an aperture of a plate serving as an intake from an ion source into a vacuum region. According to the ICP-MS disclosed in WO2002/019382, neutral particles serving as interfering particles can be prevented from entering the collision cell by arranging the intake for ions and the inlet of the collision cell on different axes.

### SUMMARY OF THE INVENTION

Interfering particles such as neutral particles and photons can be removed by providing such a configuration as to bend a traveling direction of ions without coaxially arranging an intake port from an ion source and an inlet of a collision cell. However, when two particle passage ports are arranged on different axes to remove some particles, even target ions to be detected may not be capable of passing through one of the passage ports. Therefore, there is a risk that the total amount of target ions to be fed to a detector decreases and the detection sensitivity deteriorates.

The present disclosure has been made to solve such problems, and aims to improve the detection sensitivity of target ions while preventing interfering particles causing noise from being taken into the detector.

A mass spectrometer of the present disclosure includes an ion source that ionizes a sample, a sampling cone having an intake port formed on a first axis for taking in particles in an ionization chamber in which the ion source is arranged, a cell that is provided on the first axis, the particles taken in from the sampling cone being brought into contact with a predetermined gas in the cell, a mass separation device that is provided on a second axis parallel to the first axis and separates ions on a mass-to-charge ratio basis, a detector that is provided on the second axis and detects each of the ions separated by the mass separation device, a first electrode having a particle passage port provided on the first axis between the cell and the mass separation device, and a second electrode having a particle passage port provided on the second axis between the first electrode and the mass separation device, and a control device. The control device controls the mass spectrometer into a first mode in which a detection result is obtained while the predetermined gas is not filled in the cell or a second mode in which a detection result is obtained while the predetermined gas is filled in the cell. The control device sets an electrode voltage to be applied to each of the first electrode and the second electrode in the second mode, the electrode voltage in the second mode being obtained by adding an offset determined according to a mass-to-charge ratio of a target ion to be detected to an initial voltage set as the electrode voltage in the first mode.

A setting method of the present disclosure is a method for setting an analysis condition for a mass spectrometer. The mass spectrometer includes an ion source that ionizes a sample, a sampling cone having an intake port formed on a first axis for taking in particles in an ionization chamber in which the ion source is arranged, a cell that is provided on the first axis, the particles taken in from the sampling cone being brought into contact with a predetermined gas in the cell, a mass separation device that is provided on a second axis parallel to the first axis and separates ions on a mass-to-charge ratio basis, a detector that is provided on the second axis and detects each of the ions separated by the mass separation device, a first electrode having a particle passage port provided on the first axis between the cell and the mass separation device, and a second electrode having a particle passage port provided on the second axis between the first electrode and the mass separation device. The setting method includes a step of setting a first mode in which a detection result is obtained while the predetermined gas is not filled in the cell, and a step of setting a second mode in which a detection result is obtained while the predetermined gas is filled in the cell. The setting method includes a step of setting, when the second mode is set, an electrode voltage to be applied to each of the first electrode and the second electrode in the second mode, the electrode voltage in the second mode being obtained by adding an offset determined according to a mass-to-charge ratio of a target ion to be detected to an initial voltage set as the electrode voltage in the first mode.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram schematically showing an overall configuration of an ICP-MS;

FIG. 2 is an image diagram showing a method for obtaining incident energy;

FIG. 3 is an image diagram showing effects on particles exerted by respective functions;

FIG. 4 is a flowchart showing a method for setting an axis-shifting voltage;

FIG. 5 is a flowchart showing a method of determining an adjustment voltage;

FIG. 6 is a diagram showing a relationship between a mass-to-charge ratio and the adjustment voltage;

FIG. 7 is a diagram showing scan results obtained by changing an amount of liquid fed to a standard sample; and

FIG. 8 is an image diagram showing movement of ions in an axis-shifting optical system.

### DESCRIPTION OF THE PREFERRED EMBODIMENT

Hereinafter, an embodiment of the present disclosure will be described in detail with reference to the drawings. The same or corresponding parts in the drawings are denoted by the same reference signs, and the description thereof will not be repeated.

[Overall Configuration of ICP-MS]

FIG. 1 is a diagram schematically showing an overall configuration of an ICP-MS. An ICP-MS 100 includes an ion source 1, a collision cell 2, an axis-shifting optical system 3, a mass separation device 4, a detector 5, a voltage generator 6, and a control device 7. Further, ICP-MS 100 includes an ionization chamber 10, a vacuum chamber 11 having a sampling cone 14 formed between the ionization chamber 10 and vacuum chamber 11, a vacuum chamber 12 having a skimmer 15 formed between vacuum chamber 11 and vacuum chamber 12, and a vacuum chamber 13.

ICP-MS 100 is configured such that the inside of ionization chamber 10 has an atmospheric pressure ambience, and the degree of vacuum increases in the order of vacuum chamber 11, vacuum chamber 12, and vacuum chamber 13 from ionization chamber 10. Ion source 1 is arranged in ionization chamber 10, collision cell 2 and axis-shifting optical system 3 are arranged in vacuum chamber 12, and mass separation device 4 and detector 5 are arranged in vacuum chamber 13.

Collision cell 2 is arranged on an optical axis A1 of ion source 1. Further, mass separation device 4 and detector 5 are each arranged on a detection axis A2. Detection axis A2 is an axis that is parallel to optical axis A1 and passes through positions where optical axis A1 is shifted in a direction perpendicular to optical axis A1.

Ion source 1 is configured to ionize a sample with plasma, and includes an autosampler 1a and a plasma torch 1b. Although not shown, ion source 1 further includes a nebulizer gas supply source, a plasma gas supply source, and a cooling gas supply source that supply various kinds of gases to the plasma torch 1b.

Autosampler 1a introduces a sample into plasma torch 1b. Plasma torch 1b brings argon gas into a plasma state by high-frequency inductive coupling, and ionizes the sample introduced by autosampler 1a with plasma.

Although not shown, plasma torch 1b includes a sample tube through which the liquid sample atomized by the nebulizer gas flows, a plasma gas tube formed on the outer periphery of the sample tube, and a cooling gas tube formed on the outer periphery of the plasma gas tube. Plasma gas is, for example, argon (Ar) gas.

Vacuum chamber 11 is formed between sampling cone 14 and skimmer 15. Each of sampling cone 14 and skimmer 15 has a substantially conical shape, and has an aperture that allows particles to pass therethrough at an apex portion of the cone.

Sampling cone 14 is formed such that the aperture is located on optical axis A1 passing through the tip of plasma torch 1b. Ions generated by plasma torch 1b and particles such as neutral particles generated in a plasma generation process are taken into vacuum chamber 11 through the aperture of sampling cone 14.

Skimmer 15 is formed such that the aperture thereof is located on optical axis A1. Particles in vacuum chamber 11 are taken into vacuum chamber 12 through the aperture of skimmer 15.

Vacuum chamber 12 is provided with a pull-in electrode 16, an ion lens 17, collision cell 2, a first electrode 31, and a second electrode 32. Each of pull-in electrode 16, ion lens 17, first electrode 31, and second electrode 32 is a disk-shaped electrode having a substantially circular opening. Each of pull-in electrode 16, ion lens 17, and first electrode 31 is arranged in vacuum chamber 12 such that the opening thereof is located on optical axis A1. Second electrode 32 is arranged in vacuum chamber 12 such that the opening thereof is located on detection axis A2.

Collision cell 2 includes an entrance electrode 21, an exit electrode 22 and an ion guide 23. Each of entrance electrode 21 and exit electrode 22 is a disk-shaped electrode having a substantially circular opening. The opening formed in entrance electrode 21 corresponds to an inlet of collision cell 2, and the opening formed in exit electrode 22 corresponds to an outlet of collision cell 2.

Collision cell 2 is arranged in vacuum chamber 12 such that each of the opening of the entrance electrode 21 corresponding to the inlet and the opening of exit electrode 22 corresponding to the outlet is located on optical axis A1. Ion guide 23 is configured by a plurality of rod electrodes arranged in parallel to optical axis A1.

Particles in vacuum chamber 11 pass through the aperture of skimmer 15, the opening of pull-in electrode 16, the opening of ion lens 17 and the opening of entrance electrode 21 in this order, and enter collision cell 2.

In addition to the target ions to be measured, interfering particles such as interfering ions and neutral particles that interfere with the measurement of the target ions are also taken into vacuum chamber 12. The interfering particles include those originating from gas such as Ar or the like to be used for plasma generation in ion source 1, and those originating from contaminants in the sample, additives in the sample, and the like.

Collision cell 2 is used to bring particles taken in from the inlet of collision cell 2 into contact with a predetermined gas. Collision cell 2 separates target ions and interfering particles by bringing the particles into contact with the predetermined gas.

The predetermined gas is sent from a gas supply section 8 to collision cell 2, and an appropriate type of gas is selected according to an observation object. For example, when target ions and interfering particles are separated from each other by creating an energy difference therebetween, an inert gas having low reactivity called a collision gas is selected as the predetermined gas. On the other hand, when the interfering particles and the target ions are separated from each other by utilizing the difference in reactivity therebetween, a reactive gas called a reaction gas is selected as the predetermined gas.

When a reaction gas is used as the predetermined gas, collision cell 2 is also called “reaction cell” in some cases. However, in the present specification, the collision cell is referred to even when the reaction gas is used.

Axis-shifting optical system 3 is provided between collision cell 2 and mass separation device 4. Axis-shifting optical system 3 is configured to bend a moving direction of charged ions among particles emitted from the opening of exit electrode 22 which is the outlet of collision cell 2 and send the ions to the mass separation device 4 arranged on detection axis A2.

Axis-shifting optical system 3 includes first electrode 31 and second electrode 32. Each of first electrode 31 and second electrode 32 has an opening which is formed as a passage port for particles. First electrode 31 is arranged in vacuum chamber 12 such that the opening thereof is located on optical axis A1. Second electrode 32 is arranged in vacuum chamber 12 such that the opening thereof is located on detection axis A2.

A deflection electric field is formed by offsetting a center position of a lens aperture (opening) of second electrode 32 with respect to a center position of a lens aperture (opening) of first electrode 31. An ion trajectory of ions emitted from the opening of first electrode 31 is bent under the influence of this deflection electric field. On the other hand, uncharged particles such as photons and neutral particles are unaffected by the deflection electric field, and therefore travel along optical axis A1 without being bent. As a result, the ions pass through the opening of second electrode 32, and are sent to mass separation device 4 arranged in a subsequent stage to axis-shifting optical system 3. On the other hand, the uncharged particles such as photons and neutral particles cannot pass through the opening of second electrode 32, and thus are not sent to mass separation device 4, so that photons and neutral particles which are types of interfering particles can be prevented from being taken into detector 5.

Vacuum chamber 13 has an opening formed at a position where the opening faces the opening of second electrode 32. In vacuum chamber 13, mass separation device 4 and detector 5 are arranged on detection axis A2.

Mass separation device 4 is, for example, a quadrupole mass filter, and includes a pre-rod electrodes 41 and a main rod electrode 42. Ions having a mass-to-charge ratio corresponding to a voltage applied to mass separation device 4 pass through mass separation device 4, and reach detector 5. Therefore, by changing the voltage to be applied to mass separation device 4, the ions entering mass separation device 4 are separated according to the mass-to-charge ratios thereof.

Detector 5 is, for example, a secondary electron multiplier, and it generates a detection signal corresponding to an amount of ions that have reached detector 5, and sends the detection signal to control device 7.

Control device 7 includes a CPU 71 (central processing unit) which is an arithmetic unit, and a storage device 72. An input device 73 and a display device 74 are also connected to control device 7.

CPU 71 controls the operation of each section of ICP-MS 100 by reading and executing programs stored in storage device 72. For example, CPU 71 controls voltage generator 6 to control a voltage to be applied to each section by executing the programs. The example of FIG. 1 shows a configuration in which single CPU 71 is used, but ICP-MS 100 may be configured to use a plurality of CPUs.

Storage device 72 is implemented by a non-volatile storage device such as a ROM (read only memory) or a hard disk. Storage device 72 stores programs to be executed by CPU 71, data to be used by CPU 71, or the like. The programs may be stored in a non-transitory computer-readable medium.

Input device 73 is typically a mouse, a keyboard, various buttons, a touch panel, or the like. Input device 73 accepts information required for controlling the operation of ICP-MS 100, information required for processing to be performed by control device 7, and the like by user's operation.

Display device 74 is typically a liquid crystal monitor or the like, and it displays information input by the user via input device 73, and displays analysis results, analysis conditions, and the like. Display device 74 may be configured by a printer and paper, and may display the analysis conditions and the like by printing the analysis results and the like on the paper.

[Type of Analysis Mode]

ICP-MS 100 according to the present embodiment can analyze samples in a plurality of analysis modes whose analysis methods are different from one another. The types of analysis modes are described below. Which analysis mode is used to analyze a sample is input as an analysis condition to control device 7 by input device 73 according to the user's operation.

The analysis mode includes a gasless mode in which a detection result is obtained without supplying any gas to collision cell 2, and a gas-present mode in which a detection result is obtained by supplying gas to collision cell 2.

The gasless mode obtains the detection result without supplying any gas to collision cell 2, that is, without bringing the predetermined gas into contact with particles which are taken in from sampling cone 14 and sent into collision cell 2.

In the gas-present mode, gas is supplied to collision cell 2, and the particles sent into collision cell 2 and the predetermined gas are brought into contact with each other and caused to collide and/or react with each other to obtain a detection result. Note that control device 7 may control voltage generator 6 so as to accelerate ions in collision cell 2 or form an energy barrier at the outlet of collision cell 2 in the gas-present mode.

There is a case where target ions are extremely decelerated by causing targets ions and interfering particles to collide or react with the predetermined gas. If the target ions are extremely decelerated, an arrival time required for the ions to reach detector 5 would be longer, so that a time required for measurement is longer, or the target ions would not reach the outlet of collision cell 2. Therefore, in the gas-present mode, control device 7 may control voltage generator 6 so as to accelerate the ions in collision cell 2.

When the ions in collision cell 2 are accelerated, control device 7 controls voltage generator 6 so as to cause each of the electrodes subsequent to ion guide 23, in the traveling direction of the ions, to offset by an amount of a cell voltage for accelerating the ions.

Further, when the particles sent into collision cell 2 and the predetermined gas are caused to collide with or react with each other to perform kinetic energy discrimination (KED), control device 7 controls voltage generator 6 to form an energy barrier. The energy of ions derived from a plasma gas generated by ion source 1 is generally greatly reduced due to collision with the predetermined gas as compared with the energy of target ions. By providing an energy barrier at the outlet of collision cell 2, the ions derived from the plasma gas cannot cross over the energy barrier, whereas the target ions can cross over the energy barrier, so that the target ions and the interfering particles can be separated from each other.

When an energy barrier is formed, control device 7 controls voltage generator 6 so as to cause each of the electrodes subsequent to exit electrode 22, in the traveling direction of the ions, to offset by an amount corresponding to an energy filter (hereinafter referred to as an “EF”) voltage for the energy barrier.

As described above, control device 7 controls the respective portions of ICP-MS 100 in the gas-present mode or the gasless mode and may control voltage generator 6 to offset by the amount corresponding to the cell voltage and/or the EF voltage in the gas-present mode.

[Function as Band-pass Filter of Axis-shifting Optical System]

The inventor has found that axis-shifting optical system 3 has a function as a bandpass filter. First, the inventor obtained the incident energy of ions incident on mass separation device 4 by the following method.

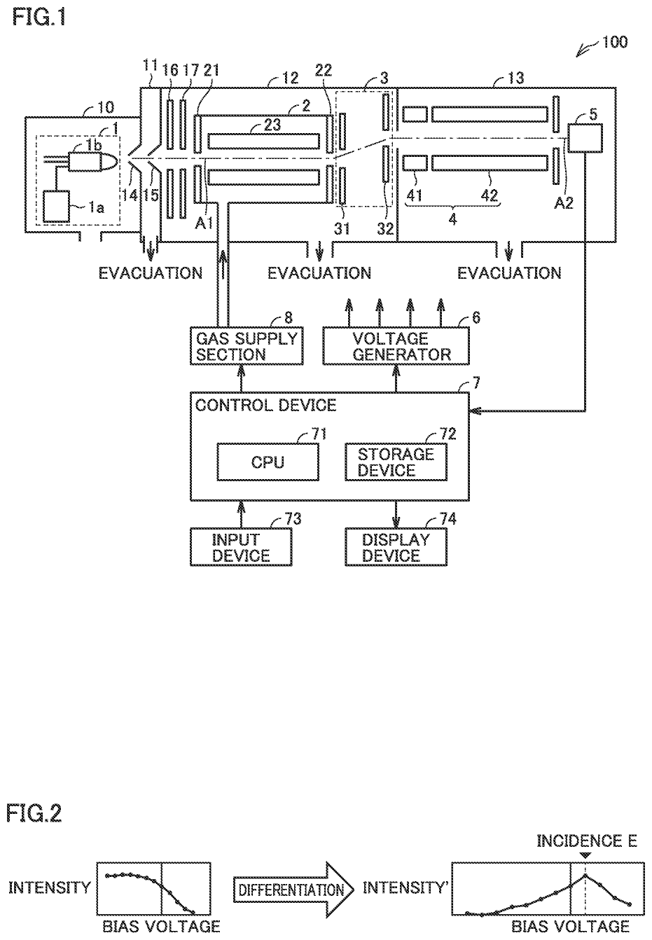

FIG. 2 is an image diagram showing a method of obtaining the incident energy. A bias voltage as a DC voltage that does not contribute to ion separation is applied to each of pre-rod electrode 41 and main rod electrode 42 of mass separation device 4. By changing this bias voltage and detecting target ions, a graph shown on the left side of FIG. 2 is obtained. Ions enter mass separation device 4 while having an energy distribution. At this time, because the bias voltage acts as an energy barrier, ions having energy lower than the bias voltage to be applied to main rod electrode 42 among the ions incident on mass separation device 4 cannot cross over the energy barrier. Therefore, the bias voltage at which the gradient of the change rate of detection intensity is maximized is regarded to correspond to the incident energy of the ions incident on mass separation device 4. Therefore, a graph shown on the left side of FIG. 2 is differentiated to obtain a graph shown on the right side of FIG. 2, the graph shown on the left side of FIG. 2 showing the relationship between the bias voltage and the detection intensity, and the bias voltage at the peak position of the graph shown on the right side of FIG. 2 is extracted. The extracted bias voltage corresponds to the incident energy of the ions.

The present inventor changed an axis-shifting voltage which is a voltage to be applied to each electrode of first electrode 31 and second electrode 32 included in axis-shifting optical system 3, applied each axis-sifting voltage, and obtained the incident energy of ions incident on mass separation device 4.

As a result, it has been found that the incident energy of ions incident on mass separation device 4 also changes when the axis-shifting voltage is changed. This indicates that an energy range that enables passage through axis-shifting optical system 3 is changed by changing the axis-shifting voltage, and thus axis-shifting optical system 3 functions as a bandpass filter.

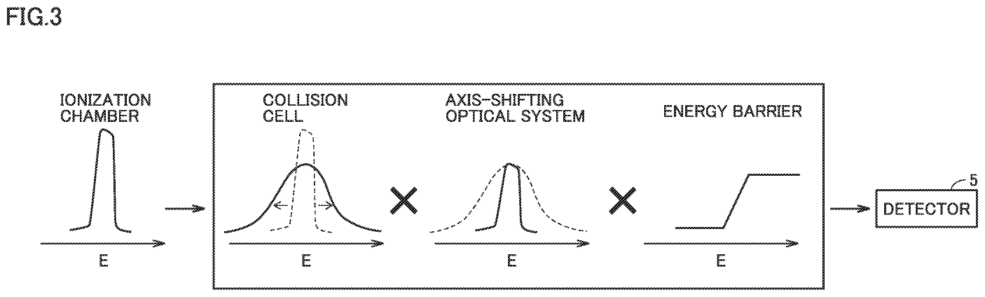

FIG. 3 is an image diagram showing effects that are exerted on particles by the respective functions. The image diagram shown in FIG. 3 is an image diagram in a case where an EF voltage for an energy barrier is applied in the gas-present mode. In FIG. 3, the effects to be exerted on the particles by the respective functions are shown by showing how the energy distribution of the particles is changed by the respective functions.

Particles in ionization chamber 10 which have been taken in from sampling cone 14 come into contact with the predetermined gas in collision cell 2. For example, a case where KED is performed by colliding the particles with the predetermined gas is considered. In this case, the kinetic energy of particles each having a large collision area is significantly reduced as compared with the kinetic energy of particles each having a small collision area. As a result, the energy distribution of the particles in collision cell 2 is broadened.

As described above, axis-shifting optical system 3 functions as a band-pass filter. Therefore, when a group of particles having a broad energy distribution enters axis-shifting optical system 3, only particles having specific energies pass through axis-shifting optical system 3.

Further, when the EF voltage is applied to the electrodes subsequent to exit electrode 22, only high-energy particles in the group of particles having a broadened energy distribution can cross over the energy barrier, and are detected by detector 5.

Since axis-shifting optical system 3 functions as a bandpass filter as described above, it is necessary for axis-shifting operation system 3 to function as a bandpass filter according to the energy when the target ions to be detected exit from collision cell 2. Therefore, it is necessary to set a set value of the axis-shifting voltage to an appropriate voltage.

[Method for Setting Axis-shifting Voltage]

ICP-MS 100 includes axis-shifting optical system 3. Axis-shifting optical system 3 can prevent neutral particles serving as interfering particles from being taken into detector 5 by arranging the respective electrodes so that the opening of first electrode 31 and the opening of second electrode 32 are located on different axes. If ICP-MS 100 is configured such that the traveling path of ions is bent in order to prevent some particles from being taken into detector 5, there is a possibility that even target ions to be detected would not be taken into detector 5.

Actually, axis-shifting optical system 3 functions as a bandpass filter. Therefore, it is necessary to set the voltage to be applied to each electrode of first electrode 31 and second electrode 32 included in axis-shifting optical system 3 so as to improve the passage rate at which the target ions pass through axis-shifting optical system 3.

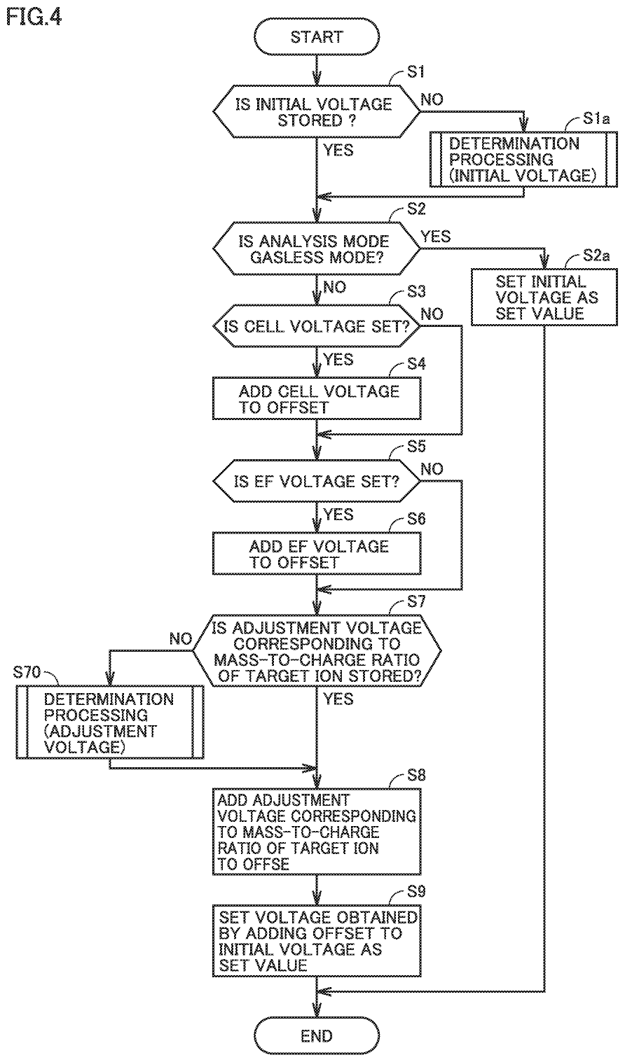

A method of setting the axis-shifting voltage will be described with reference to FIG. 4. FIG. 4 is a flowchart showing the method of setting the axis-shifting voltage. Note that the step is simply abbreviated as “S” below. Each step shown in FIG. 4 is executed by control device 7.

In S1, control device 7 determines whether an initial voltage Vᵢ corresponding to the mass-to-charge ratio of the target ions is stored in storage device 72. Initial voltage Vᵢ is a set value to be set in the gasless mode. When determining that initial voltage Vᵢ is not stored in storage device 72 (NO in SI), control device 7 advances the processing to S1a. When determining that initial voltage Vᵢ is stored in storage device 72 (YES in S1), control device 7 advances the processing to S2 without executing S1a.

In Sla, control device 7 executes determination processing for determining initial voltage Vᵢ. In the determination processing, control device 7 analyzes a standard sample corresponding to the mass-to-charge ratio of target ions in the gas less mode while changing the axis-shifting voltage, and an axis-shifting voltage that provides the highest detection intensity as a detection result is determined as initial voltage Vᵢ. Note that the determination processing may include a step of storing obtained initial voltage Vᵢ in storage device 72 in association with the mass-to-charge ratio.

In S2, control device 7 determines whether an analysis mode is the gasless mode based on an analysis condition input via input device 73. When determining that the analysis mode is the gasless mode (YES in S2), control device 7 sets initial voltage Vᵢ as the set value in S2a, and terminates the processing. Note that the voltage to be applied to each electrode of pull-in electrode 16, ion lens 17, entrance electrode 21, exit electrode 22, and ion guide 23, and the bias voltage to be applied to each electrode of pre-rod electrode 41 and main rod electrode 42 are set to voltages that provide the highest detection intensity as a detection result like the axis-shifting voltage.

When determining that the analysis mode is not the gasless mode (NO in S2), that is, when determining that the analysis mode is the gas-present mode, control device 7 advances the processing to S3. Subsequently to S3, control device 7 determines the set value of the axis-shifting voltage in the gas-present mode. In the gas-present mode, control device 7 sets, as the set value of the axis-shifting voltage, a voltage obtained by adding an offset set according to the mass-to-charge ratio of the target ions to initial voltage Vᵢ.

In S3, control device 7 determines whether a cell voltage V_{C} has been set based on an analysis condition input through input device 73. As described above, cell voltage V_{C} is a voltage for accelerating ions in collision cell 2, and is the voltage to be applied to each electrode subsequent to ion guide 23 in the traveling direction of the ions. When determining that cell voltage V_{C} has been set (YES in S3), control device 7 advances the processing to S4. On the other hand, when determining that cell voltage V_{C} has not been set (NO in S3), control device 7 advances the processing to S5 without executing S4.

In S4, control device 7 adds cell voltage V_{C} to the offset. Cell voltage V_{C} is predetermined regardless of the mass-to-charge ratio of target ions. As described above, cell voltage V_{C} is a voltage to be applied to each electrode subsequent to ion guide 23 in the traveling direction of ions, and thus cell voltage V_{C} is also applied to each electrode of first electrode 31 and second electrode 32. Therefore, when cell voltage V_{C} has been set, control device 7 needs to cause each electrode of first electrode 31 and second electrode 32 to offset by the amount corresponding to the cell voltage.

In S5, control device 7 determines whether an EF voltage V_{EF} has been set based on an analysis condition input through input device 73. As described above, EF voltage V_{EF} is a voltage to be applied to form an energy barrier when KED is performed. When determining that EF voltage V_{EF} has been set (YES in S5), control device 7 advances the processing to S6. On the other hand, when determining that EF voltage V_{EF} has not been set (NO in S5), control device 7 advances the processing to S7 without executing S6.

In S6, control device 7 adds EF voltage V_{EF} to the offset. EF voltage V_{EF} is predetermined regardless of the mass-to-charge ratio of target ions. As described above, EF voltage V_{EF} is a voltage to be applied to each electrode subsequent to exit electrode 22 in the traveling direction of ions, and thus it is also applied to each electrode of first electrode 31 and second electrode 32. Therefore, when EF voltage V_{EF} has been set, control device 7 needs to cause each electrode of first electrode 31 and second electrode 32 to offset by the amount corresponding to the EF voltage.

In S7, control device 7 determines whether an adjustment voltage V_{ad} corresponding to the mass-to-charge ratio of the target ions has been stored in storage device 72. Unlike cell voltage V_{C} and EF voltage V_{EF} which are set uniformly regardless of the mass-to-charge ratio, adjustment voltage V_{ad} is a voltage to be determined according to the mass-to-charge ratio of the target ions, and stored in storage device 72 in association with the mass-to-charge ratio. The mass-to-charge ratio of the target ions is included, for example, in analysis conditions input by a user through input device 73.

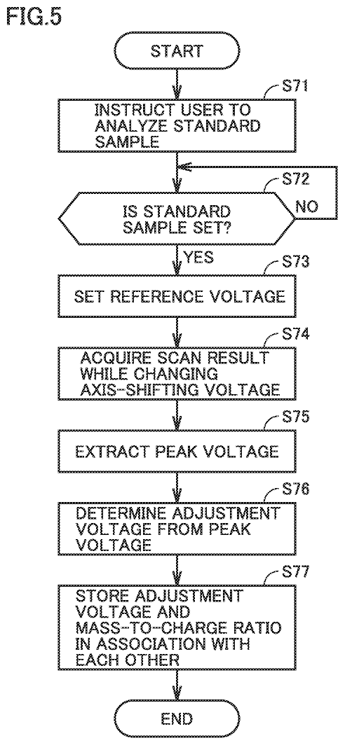

When determining that adjustment voltage V_{ad} has not been stored in storage device 72 (NO in S7), control device 7 executes determination processing for determining adjustment voltage Vᵢ, in S70. The determination processing for determining adjustment voltage V_{ad} will be described later with reference to FIG. 5. When determining that adjustment voltage V_{ad} has been stored in storage device 72 (YES in S7), control device 7 advances the processing to S8.

In S8, control device 7 adds adjustment voltage V_{ad} corresponding to the mass-to-charge ratio of the target ions to the offset.

In S9, control device 7 sets, as a set value, a voltage obtained by adding the offset to initial voltage Vᵢ. In other words, the offset includes at least adjustment voltage V_{ad} determined according to the mass-to-charge ratio, and may include cell voltage V_{C} and/or EF voltage V_{EF}.

As described above, control device 7 sets the voltage obtained by adding the offset to initial voltage Vᵢ as the set value of the axis-shifting voltage. As shown in S7 to S8, since the offset includes adjustment voltage V_{ad} according to the mass-to-charge ratio of the target ions regardless of the analysis condition, it can be also said that the offset is determined according to the mass-to-charge ratio of the target ions.

In other words, in the gas-present mode, control device 7 sets, as the set value of the axis-shifting voltage, the voltage obtained by adding the offset determined according to the mass-to-charge ratio of the target ions to initial voltage Vᵢ which is the set value in the gasless mode.

[Method for Determining Adjustment Voltage]

FIG. 5 is a flowchart showing a method for determining the adjustment voltage. The flowchart shown in FIG. 5 corresponds to the determination processing to be executed in S70 of FIG. 4. Each step shown in FIG. 5 is executed by control device 7.

In S71, control device 7 instructs the user to analyze a standard sample. Specifically, control device 7 displays, on display device 74, instruction information for setting the standard sample in autosampler 1a. Here, the standard sample is a sample consisting of a specific component. The specific component is appropriately selected according to the target ions to be measured. The specific component may be a component that becomes target ions when ionized, or a component that becomes ions each having a mass-to-charge ratio that is the same as or very close to the mass-to-charge ratio of the target ions when ionized. Note that the standard sample is required not to contain any component that will serve as interfering particles during the measurement of the specific component, and may contain components other than the specific component.

In S72, control device 7 determines whether the standard sample has been set. As an example, control device 7 determines, based on information input by the user through input device 73, whether the standard sample has been set. When determining that the standard sample has been set (YES in S72), control device 7 advances the processing to S73.

In S73, control device 7 sets a reference voltage. The reference voltage is a voltage to be set according to the analysis condition, and is the voltage obtained by adding initial voltage Vᵢ to a voltage which is set according to the analysis condition regardless of the mass-to-charge ratio of the target ions. Voltages which are set according to the analysis condition regardless of the mass-to-charge ratio of the target ions are cell voltage V_{C} and EF voltage V_{EF}.

In S74, control device 7 obtains a detection result of the standard sample while changing the axis-shifting voltage with the reference voltage being centered, thereby obtaining a scanning result of the axis-shifting voltage. Specific ions obtained by ionizing the specific component contained in the standard sample are detected by detector 5, thereby obtaining a detection result of the standard sample. The scan result of the axis-shifting voltage is the relationship between the axis-shifting voltage and the detection intensity of specific ions.

In S75, control device 7 extracts, from the scan result, a peak voltage at which the highest detection intensity is obtained.

In S76, control device 7 determines adjustment voltage V_{ad} from the peak voltage. The detection intensity being highest when the peak voltage is set means that a larger number of specific ions can pass through axis-shifting optical system 3 by setting the peak voltage. Therefore, control device 7 determines adjustment voltage V_{ad} such that the peak voltage becomes the axis-shifting voltage in the gas-present mode. More specifically, based on the reference voltage set in S73, control device 7 determines a variation value from the reference voltage to the peak voltage as adjustment voltage V_{ad}. Note that the variation value from initial voltage Vᵢ to the peak voltage corresponds to the offset.

In S77, control device 7 stores determined adjustment voltage V_{ad} and the mass-to-charge ratio of the specific ions in association with each other in storage device 72, and terminates the processing. By storing determined adjustment voltage V_{ad} and the mass-to-charge ratio of the specific ions in association with each other, when analyzing target ions under the same analysis condition, it is not necessary to perform the determination processing for determining adjustment voltage V_{ad} again, so that the axis-shifting voltage can be set efficiently.

As described above, the control device 7 analyzes the standard sample of the specific ions to determine adjustment voltage Vad to be set when the specific ions are the target ions.

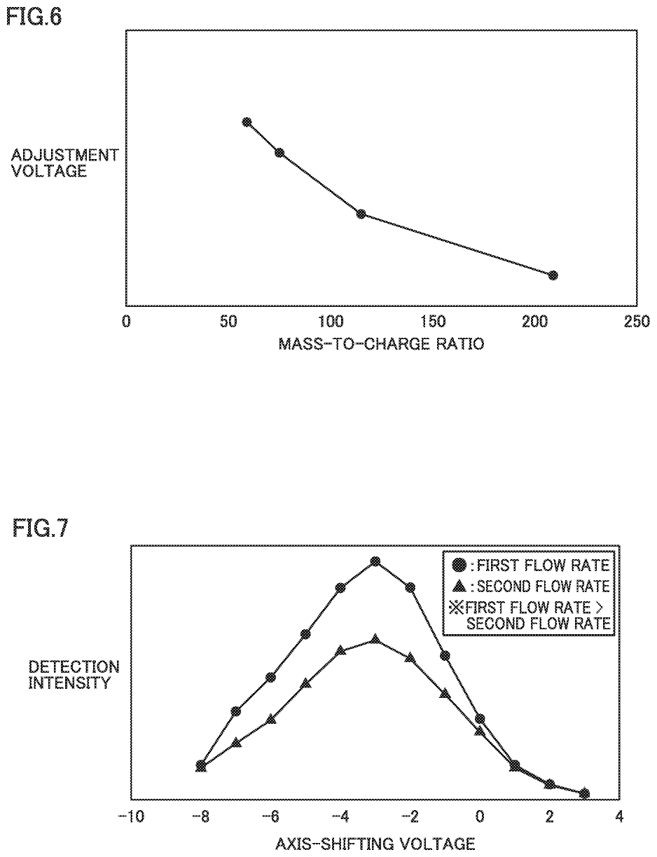

FIG. 6 is a diagram showing the relationship between the mass-to-charge ratio and the adjustment voltage. The relationship between the mass-to-charge ratio and adjustment voltage V_{ad} is obtained by analyzing a plurality of standard samples. Offset information indicating the relationship between the mass-to-charge ratio and adjustment voltage V_{ad} is stored in storage device 72, for example. Therefore, control device 7 is configured to be capable of acquiring the offset information. Note that the offset information may be stored in a server which is configured to be communicable with control device 7 via a network.

Note that adjustment voltage V_{ad} changes according to whether cell voltage V_{C} is applied or whether EF voltage V_{EF} is applied. Therefore, it is preferable that the offset information is provided according to analysis conditions regarding cell voltage V_{C} and EF voltage V_{EF}. Although the offset information is described as the relationship between the mass-to-charge ratio and adjustment voltage V_{ad}, the offset information may be the relationship between the mass-to-charge ratio and the offset in which cell voltage V_{C} and/or EF voltage V_{EF} is added to adjustment voltage V_{ad}.

In S7 and S8 of FIG. 4, control device 7 may determine adjustment voltage V_{ad} corresponding to the input mass-to-charge ratio based on the offset information. Even when adjustment voltage V_{ad} corresponding to the input mass-to-charge ratio is not included in the offset information, control device 7 may determine adjustment voltage V_{ad} corresponding to a mass-to-charge ratio closest to the input mass-to-charge ratio as adjustment voltage V_{ad} corresponding to the input mass-to-charge ratio.

FIG. 7 is a diagram showing scan results obtained by changing the liquid feeding rate of the standard sample. A plot indicated by black circles in FIG. 7 indicates a scan result obtained when the standard sample is sent to plasma torch 1b at a first flow rate by autosampler 1a. A plot indicated by black triangles in FIG. 7 indicates a scan result obtained when the standard sample is sent to plasma torch 1b at a second flow rate smaller than the first flow rate by autosampler 1a. The horizontal axis of a graph shown in FIG. 7 is the axis-shifting voltage when the reference voltage is set to 0.

As shown in FIG. 7, the peak voltage does not change regardless of the flow rate of the standard sample sent to plasma torch 1b. Therefore, control device 7 can set adjustment voltage V_{ad} regardless of the liquid feeding rate.

Further, as shown in FIG. 7, the variation in intensity is relatively small before and after the peak voltage. Therefore, by determining adjustment voltage V_{ad} such that the set value of the axis-shifting voltage in the gas-present mode is equal to the peak voltage, it is possible to reduce the variation range of the detection intensity when the voltage value of the set axis-shifting voltage changes, so that the detection result can stably obtained.

[Movement of Ions in Axis-shifting Optical System]

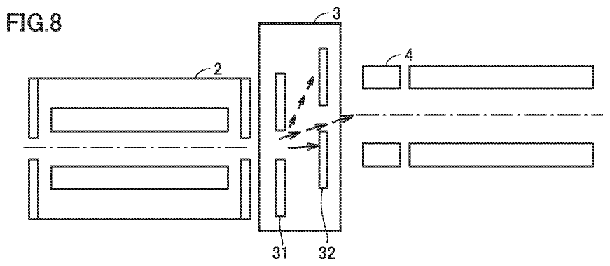

FIG. 8 is an image diagram showing the movement of ions in the axis-shifting optical system. The lengths of arrows in FIG. 8 indicate the velocities of ions, and FIG. 8 shows that the velocity is higher as the arrow is longer.

When the mass is the same, the energy possessed by an ion and the velocity of the ion are in a proportional relationship. Accordingly, when the velocity of an ion is too high, the ion has a large energy. Therefore, as shown in FIG. 8, the traveling direction of the ion is not greatly bent, so that the ion cannot pass through the opening of second electrode 32, and cannot reach mass separation device 4. On the other hand, when the velocity of an ion is too low, the ion has a small energy. Therefore, as shown in FIG. 8, the traveling direction of the ion is too greatly bent, so that the ion cannot pass through the opening of second electrode 32, and cannot reach mass separation device 4. Therefore, it is necessary to set the axis-shifting voltage such that the velocity of the ion which is passing through first electrode 31, that is, the energy possessed by the ion is equal to an appropriate energy.

In the gas-present mode, the energy possessed by ions emitted from collision cell 2 changes from the energy possessed when the ions are taken in from sampling cone 14 because the ions come into contact with the predetermined gas in collision cell 2. Further, the effect of the predetermined gas on the ions differs depending on the type of the ions.

In other words, the variation amount in the energy of the ions caused by the contact with the predetermined gas differs depending on the type of the ions.

Therefore, even if initial voltage Vᵢ is set according to the target ions in the gasless mode and an offset is uniformly added to initial voltage Vᵢ regardless of the mass-to-charge ratio, the energy of the ions which are passing through first electrode 31 is not set to an appropriate energy.

In the present embodiment, a voltage obtained by adding the offset determined according to the mass-to-charge ratio of the target ions to initial voltage Vᵢ is set as the axis-shifting voltage in the gas-present mode by control device 7. Therefore, the energy of the ions which are passing through first electrode 31 can be set to an appropriate energy, and the passage rate of the target ions through axis-shifting optical system 3 can be improved, so that the detection sensitivity can be enhanced.

[Aspect]

It is understood by a person skilled in the art that the above-described embodiment is a specific example of the following aspect.

(First Item) A mass spectrometer according to one aspect includes an ion source that ionizes a sample, a sampling cone having an intake port formed on a first axis for taking in particles in an ionization chamber in which the ion source is arranged, a cell that is provided on the first axis, the particles taken in from the sampling cone being brought into contact with a predetermined gas in the cell, a mass separation device that is provided on a second axis parallel to the first axis and separates ions on a mass-to-charge ratio basis, a detector that is provided on the second axis and detects each of the ions separated by the mass separation device, a first electrode having a particle passage port provided on the first axis between the cell and the mass separation device, a second electrode having a particle passage port provided on the second axis between the first electrode and the mass separation device, and a control device. The control device controls the mass spectrometer into a first mode in which a detection result is obtained while the predetermined gas is not filled in the cell or a second mode in which a detection result is obtained while the predetermined gas is filled in the cell. The control device sets an electrode voltage to be applied to each of the first electrode and the second electrode in the second mode, the electrode voltage in the second mode being obtained by adding an offset determined according to a mass-to-charge ratio of a target ion to be detected to an initial voltage set as the electrode voltage in the first mode.

According to the mass spectrometer described in the first item, since the passage port of the first electrode and the passage port of the second electrode are located on different axes, interfering particles such as photons and neutral particles can be prevented from passing through the passage port of the second electrode and from being taken into the mass separation device and detected by the detector. Furthermore, since the electrode voltage set in the second mode includes an offset determined according to the mass-to-charge ratio of the target ion, an appropriate electrode voltage corresponding to the target ion can be set, and the detection sensitivity of the target ion can be enhanced.

(Second Item) In the mass spectrometer according to the first item, the control device executes determination processing determining the offset when a first ion having a first mass-to-charge ratio is set as the target ion by analyzing, in the second mode, a first standard sample including a first component having the first mass-to-charge ratio when ionized. The determination processing includes: acquiring a scan result showing a relationship between detection intensity of the first ion and the electrode voltage by detecting the first ion in the second mode by changing the electrode voltage; and determining the offset when the first ion is the target ion based on a peak voltage with the highest detection intensity extracted from the scan result.

According to the mass spectrometer described in the second item, since the offset is determined based on the peak voltage at which the detection intensity is highest, the detection sensitivity of the target ion can be enhanced by performing analysis under the electrode voltage set by the determined offset.

(Third Item) In the mass spectrometer described in the second item, the control device stores the relationship between the determined offset and the mass-to-charge ratio in a storage.

According to the mass spectrometer described in the third item, by storing the relationship between the determined offset and the mass-to-charge ratio in the storage section, the electrode voltage can be efficiently set when the target ion is analyzed under the same analysis condition.

(Fourth Item) In the mass spectrometer described in any one of the first item to the third item, the offset includes a predetermined energy-barrier voltage regardless of a mass-to-charge ratio.

According to the mass spectrometer described in the fourth item, the target ion and an interfering substance can be separated from each other by the energy barrier when energy discrimination is executed by bringing the particles into contact with the predetermined gas in the cell.

(Fifth Item) In the mass spectrometer described in any one of the first item to the fourth item, the control device sets a cell voltage predetermined regardless of the mass-to-charge ratio as a voltage to be applied to an ion guide equipped in the cell in the second mode. The offset includes the cell voltage.

According to the mass spectrometer described in the fifth item, even when the target ion is brought into contact with the predetermined gas in the cell and the velocity of the target ion is extremely reduced, the target ion can be accelerated, so that the target ion can be emitted from an outlet of the cell.

(Sixth item) In the mass spectrometer described in any one of the first item to the fifth item, the control device acquires offset information indicating the relationship between a mass-to-charge ratio and the offset when an ion having the mass-to-charge ratio is set as the target ion, and when an input of a mass-to-charge ratio of the target ion is accepted, the control device determines an offset corresponding to the input mass-to-charge ratio based on the offset information.

According to the mass spectrometer described in the sixth item, the electrode voltage can be set efficiently.

(Seventh Item) In the mass spectrometer described in any one of the first item to the sixth item, the value of the offset may decrease as the value of the mass-to-charge ratio increases.

According to the mass spectrometer described in the seventh item, the value of the offset is appropriately determined in accordance with the value of the mass-to-charge ratio.

(Eighth Item) A setting method according to one aspect is a method for setting an analysis condition for a mass spectrometer. The mass spectrometer includes an ion source that ionizes a sample, a sampling cone having an intake port formed on a first axis for taking in particles in an ionization chamber in which the ion source is arranged, a cell that is provided on the first axis, the particles taken in from the sampling cone being brought into contact with a predetermined gas in the cell, a mass separation device that is provided on a second axis parallel to the first axis and separates ions on a mass-to-charge ratio basis, a detector that is provided on the second axis and detects each of the ions separated by the mass separation device, a first electrode having a particle passage port provided on the first axis between the cell and the mass separation device, and a second electrode having a particle passage port provided on the second axis between the first electrode and the mass separation device. The setting method includes a step of setting a first mode in which a detection result is obtained while the predetermined gas is not filled in the cell, and a step of setting a second mode in which a detection result is obtained while the predetermined gas is filled in the cell. Further, the setting method includes a step of setting, when the second mode is set, an electrode voltage to be applied to each of the first electrode and the second electrode in the second mode, the electrode voltage in the second mode being obtained by adding an offset determined according to a mass-to-charge ratio of a target ion to be detected to an initial voltage set as the electrode voltage in the first mode.

According to the setting method described in the seventh item, since the passage port of the first electrode and the passage port of the second electrode are located on different axes, interfering particles such as photons and neutral particles are prevented from passing through the passage port of the second electrode, and from being taken into the mass separation device and detected by the detector. Furthermore, since the electrode voltage set in the second mode includes the offset determined according to the mass-to-charge ratio of the target ion, an appropriate electrode voltage corresponding to the target ion can be set, and the detection sensitivity of the target ion can be enhanced.

Although an embodiment of the present invention has been described, the embodiment disclosed at this time should be considered as an example in all respects and not to be restrictive. The scope of the present invention is indicated by claims, and it is intended to include all changes within the meaning and range of equivalents to the claims.

What is claimed is:

1. A mass spectrometer comprising:
an ion source that ionizes a sample;
a sampling cone having an intake port formed on a first axis for taking in particles in an ionization chamber in which the ion source is arranged;
a cell that is provided on the first axis, the particles taken in from the sampling cone being bought into contact with a predetermined gas in the cell;
a mass separation device that is provided on a second axis parallel to the first axis and separates ions on a mass-to-charge ratio basis;
a detector that is provided on the second axis and detects each of the ions separated by the mass separation device;
a first electrode having a particle passage port provided on the first axis between the cell and the mass separation device;
a second electrode having a particle passage port provided on the second axis between the first electrode and the mass separation device; and
a control device,
wherein the control device controls the mass spectrometer into a first mode in which a detection result is obtained while the predetermined gas is not filled in the cell or a second mode in which a detection result is obtained while the predetermined gas is filled in the cell, and sets an electrode voltage to be applied to each of the first electrode and the second electrode in the second mode, the electrode voltage in the second mode being obtained by adding an offset determined according to a mass-to-charge ratio of a target ion to be detected to an initial voltage set as the electrode voltage in the first mode.

2. The mass spectrometer according to claim 1, wherein the control device executes determination processing determining the offset when a first ion having a first mass-to-charge ratio is set as the target ion by analyzing, in the second mode, a first standard sample including a first component having the first mass-to-charge ratio when ionized,
the determination processing comprising:
acquiring a scan result showing a relationship between detection intensity of the first ion and the electrode voltage by detecting the first ion in the second mode by changing the electrode voltage; and
determining the offset when the first ion is the target ion based on a peak voltage with the highest detection intensity extracted from the scan result.

3. The mass spectrometer according to claim 1, wherein the control device executes determination processing determining the offset when a first ion having a first mass-to-charge ratio is set as the target ion by analyzing, in the second mode, a first standard sample including a first component having the first mass-to-change ratio when ionized,
the determination processing comprising:
acquiring a scan result showing a relationship between detection intensity of the first ion and the electrode voltage by detecting the first ion in the second mode by changing the electrode voltage;
determining the offset when the first ion is the target ion based on a peak voltage with the highest detection intensity extracted from the scan result; and
storing a relationship between the determined offset and the first mass-to-charge ratio in a storage.

4. The mass spectrometer according to claim 1, wherein the offset includes a predetermined energy-barrier voltage regardless of a mass-to-charge ratio.

5. The mass spectrometer according to claim 1, wherein:
the control device sets a cell voltage predetermined regardless of the mass-to-charge ratio as a voltage to be applied to an ion guide equipped in the cell in the second mode, and
the offset includes the cell voltage.

6. The mass spectrometer according to claim 1, wherein the control device acquires offset information indicating a relationship between a mass-to-charge ratio and the offset when an ion having the mass-to-charge ratio is set as the target ion, and
when an input of a mass-to-charge ratio of the target ion is accepted, the control device determines the offset corresponding to the input mass-to-charge ratio based on the offset information.

7. The mass spectrometer according to claim 1, wherein a value of the offset decreases as a value of the mass-to-charge ratio increases.

8. A setting method for an analysis condition for a mass spectrometer, the mass spectrometer comprising:
an ion source that ionizes a sample;
a sampling cone having an intake port formed on a first axis for taking in particles in an ionization chamber in which the ion source is arranged;
a cell that is provided on the first axis, the particles taken in from the sampling cone being brought into contact with a predetermined gas in the cell;
a mass separation device that is provided on a second axis parallel to the first axis and separates ions on a mass-to-charge ratio basis;
a detector that is provided on the second axis and detects each of the ions separated by the mass separation device;
a first electrode having a particle passage port provided on the first axis between the cell and the mass separation device; and
a second electrode having a particle passage port provided on the second axis between the first electrode and the mass separation device,
wherein the setting method comprises:
setting a first mode in which a detection result is obtained while the predetermined gas is not filled in the cell;
setting a second mode in which a detection result is obtained while the predetermined gas is filled in the cell; and
setting, when the second mode is set, an electrode voltage to be applied to each of the first electrode and the second electrode in the second mode, the electrode voltage in the second mode being obtained by adding an offset determined according to a mass-to-charge ratio of a target ion to be detected to an initial voltage set as the electrode voltage in the first mode.
